(19) United States
(12) Patent Application Publication
(10) Pub. No.: US 2005/0049976 A1
(43) Pub. Date: Mar. 3, 2005

(54) Remotely licensing configurable network diagnostic modules

(76) Inventor: Harold (Haoran) Yang, Milpitas, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/704,301

(22) Filed: Nov. 7, 2003

Related U.S. Application Data
(60) Provisional application No. 60/498,241, filed on Aug. 26, 2003.

(51) Int. Cl. G06F 17/60

(52) U.S. Cl. 705/67

(57) ABSTRACT

The principles of the present invention extend to remotely licensing configurable network diagnostic modules. License keys included encrypted serial numbers are stored in blades that can be inserted into and removed form diagnostic chasses. Serial numbers are also stored in read only memory of blades. Each diagnostic chassis includes software for decrypting a serial number portion of al license key and comparing the decrypted serial number to a stored serial to determine of the features of the license key correspond to blade. A diagnostic chassis requests license upgrades from a licensing server. The licensing serer encrypts a serial number and feature ID string into a new license key. The new license key is sent to the diagnostic chassis and stored in a blade at the diagnostic chassis. Since license keys are stored in blades, the blades can be moved between chasses while still retaining licensed features.

### CROSS REFERENCE TO RELATED APPLICATIONS

The present application claims priority to U.S. Provisional Patent Application Ser. No. 60/498,241 entitled “Remotely Licensing Configurable Network Diagnostic Modules” filed Aug. 26, 2003, which is hereby incorporated by reference.

### BACKGROUND OF THE INVENTION

1. The Field of the Invention

The present invention relates to software licensing, and more specifically, to remotely licensing software used at configurable network diagnostic modules to implement network diagnostic functions.

2. Background and Relevant Art

Computer systems and related technology affect many aspects of society. Indeed, the computer system's ability to process information has transformed the way we live and work. Computer systems now commonly perform a host of tasks (e.g., word processing, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, many tasks performed at a computer system (e.g., voice communication, accessing electronic mail, controlling home electronics, web browsing) include electronic communication between a number of computer systems and/or other electronic devices via wired and/or wireless computer networks.

Historically, many software applications have been distributed on CD-ROM. To activate a software application, a computer system user would load the CD-ROM at a computer system and execute an install program. The install program would then copy the appropriate files to a mass storage device (e.g., a disk drive) at the computer system. During the install process the user may be prompted to enter an activation code to activate the software application.

The activation code is typically a sequence of alphanumeric characters printed on the CD-ROM packaging or printed on a licensing agreement bundled along with the CD-ROM. Entering the activation code subjects the user to the terms of the licensing agreement (which typically includes language prohibiting further distribution of the software application) and also provides some evidence that the user has a legitimate copy of the software application. Unfortunately, alphanumeric characters can easily be copied and distributed. Thus, an activation code could be given to a user to activate an unauthorized and/or illegally obtained copy of the software application.

To reduce unauthorized distribution of activation codes, some software distributors embed special instructions on installation CD-ROMs. The embedded instructions tie a specified activation code to a specified CD-ROM such that the specified activation code can only be used to activate a software application installed from the specified CD-ROM. That is, the specified activation code can not generally be used to activate other copies of the software application installed from other CD-ROMs that are not tied to the specified activation code. However, there are a number of ways to circumvent the restrictions on distribution resulting from embedded special instructions. For example, a user can simply make a copy of the installation CD-ROM and give the copy and activation code to another user or, after installing the software application on one computer system, give the installation CD-ROM to another user. The other user could then use the copy or the original installation CD-ROM to install another copy of the software application.

Further, distribution of a software application on CD-ROM can be somewhat costly. A software distributor is required to obtain a CD-ROM disc for each copy of the software application that is to be offered for sale. The software distributor is also required to have mechanisms in place for copying the software application onto each CD-ROM disc. If the software application (e.g., a word processor or electronic mail application) is to be made available to the general public the cost in obtaining and creating appropriate CD-ROM discs can be significant.

Unfortunately, some computing devices (e.g., PDA's) do not have components for reading CD-ROM discs (or other types of removable media) and thus software applications for these computing devices or components cannot be loaded from CD-ROM discs (or other removable media). Accordingly, to reduce the costs associated with distributing software applications and increase availability to computing devices and components that lack CD-ROM access, some software distributors distribute software applications via computer networks, such as, for example, the Internet. For example, through a Web browser a user can access a software distribution Web site and download an installation program. Execution of the installation program can result in access to additional networked computers, for example, on the software distributor's network, that complete the installation process. Alternately, a complete software application may be downloaded from the software distributor and thus no further connection to the software distributor's network is required.

However, the use of computer networks to distribute software applications also makes unauthorized and/or illegal distribution of software applications easier. Further, a user is still typically provided an activation code that is entered at some point during the installation process. These activation codes can be included in an electronic message, such as, for example, an electronic mail message, that is sent to the user. Thus, not only does the user have access to the activation code, but there is some potential that a malicious user may intercept the electronic message and obtain the activation code. Therefore, systems, methods, and computer program products for reducing unauthorized distribution of software would be advantageous.

### BRIEF SUMMARY OF THE INVENTION

The foregoing problems with the prior state of the art are overcome by the principles of the present invention, which are directed towards methods, systems, computer program products, for remotely licensing configurable network diagnostic modules. A diagnostic chassis contains one or more configurable network diagnostic modules. Each network diagnostic module includes one or more programmable logic modules (e.g., one or more Field Programmable Gate Arrays (“FPGAs”)) that include circuitry for implementing any of a plurality of different network diagnostic functions (e.g., network analyzer, jammer, generator, bit rate error tester, etc). Each programmable logic module controls one or more test ports that provide interfaces for different physical configurations (e.g., Gigabit Ethernet, Fiber Distributed Data Interface, Fiber Channel, etc.) and that can interoperate with the programmable logic module to implement a selected network diagnostic function. From time to time, the network diagnostic modules can be licensed to implement new network diagnostic functions for new physical configurations.

A licensee, such as, for example, a diagnostic chassis, identifies a stored serial number for a diagnostic module that is to be licensed for a new diagnostic feature. The licensee sends an upgrade request (e.g., including the serial number and a request for the new diagnostic feature) to a licensor, such as, for example, a licensing computer system. The licensor receives the upgrade request from the licensee. The licensor generates a new feature ID string, for example, that collectively represents the currently licensed features of the diagnostic module and the requested new diagnostic feature.

The licensor encrypts the new feature ID string along with the serial number (potentially retrieved form a licensing database) into a new license key. The licensor can utilize a private key to encrypt new feature ID string and serial number into new license key 183. Since the new feature ID string is encrypted it has a reduced chance of providing a malicious user with any information on how licensing strings are formulated. The licensor returns the new license key to the licensee.

The licensee receives the new license key. The licensee can store the new license key in programmable memory, potentially overwriting an existing license key. The licensee decrypts the new license key to reveal the new feature ID string and the serial number. The licensee can utilize a public key (that corresponds to the private key) to decrypt the new license key. The public key can be embedded in software at a diagnostic chassis such that it would be difficult for a user of the diagnostic chassis to access the public key. The licensee compares the reveal serial number to a stored serial number (e.g., stored in ROM of the diagnostic module) to determine if the reveal feature ID string corresponds to the diagnostic module.

When a stored serial number matches a revealed serial number, this can indicate that the diagnostic module storing the new license key is licensed to implement the features represented in revealed he feature ID string. Accordingly, a licensing module at a diagnostic chassis can allow the diagnostic module to implement the represented features. If the diagnostic module is moved to a new diagnostic chassis, the new diagnostic chassis can decrypt the license key and perform a similar comparison. Thus, licensed features of a diagnostic module are easily identifiable at a new diagnostic chassis even though the licensed features were actually upgraded at the new diagnostic chassis.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of network architecture and associated modules and data structures for remotely licensing configurable network diagnostic modules in accordance with the principles of the present invention.

FIG. 2 illustrates a flowchart of a method for remotely licensing configurable network diagnostic modules in accordance with the principles of the present invention.

FIG. 3 illustrates an example chassis computer system architecture including a plurality of network diagnostic modules in accordance with the principles of the present invention.

FIG. 4 illustrates a suitable operating environment for the principles of the present invention.

FIG. 5 illustrates an example of a network diagnostic module and test ports that can interoperate to implement a network diagnostic function in accordance with the principles of the present invention.

### DETAILED DESCRIPTION OF THE PREFERRED EMBODIMENTS

The principles of the present invention provide for remotely licensing configurable network diagnostic modules. A diagnostic chassis contains one or more configurable network diagnostic modules. Each network diagnostic module includes one or more programmable logic modules (e.g., one or more Field Programmable Gate Arrays (“FPGAs”)) having circuitry for implementing any of a plurality of different network diagnostic functions (e.g., network analyzer, jammer, generator, bit rate error test, etc). Each programmable logic module controls one or more test ports that provide interfaces for different physical configurations (e.g., Gigabit Ethernet, Fiber Distributed Data Interface, Fiber Channel, etc.) and that can interoperate with the programmable logic module to implement a selected network diagnostic function. In some embodiments, a network diagnostic module is included in a printed circuit board (hereinafter referred to as a “card” or “blade”) that is inserted into an appropriate receptacle at a diagnostic chassis (e.g., using a Peripheral Component Interconnect (“PCI”) interface). Accordingly, the network diagnostic module may exchange data through electrical contacts of the receptacle.

Generally, a network diagnostic module receives a bit file with instructions for implementing a selected diagnostic function at one or more test ports that interface with a network. A bit file can be received from a mass storage device or even from a memory location at the network diagnostic module. Instructions can include computer-executable or computer-interpretable code that is processed by the network diagnostic module to implement the selected network diagnostic function. The network diagnostic module identifies a programmable logic module (e.g., an FPGA) that controls the one or more test ports. The network diagnostic module loads the included instructions at the identified programmable logic module to cause the programmable logic module and the one or more test ports to interoperate to implement the selected diagnostic function. Accordingly, instructions contained in a bit file can be loaded at an FPGA to cause the FPGA to implement any of a network analyzer, jammer, bit error rate tester, generator, etc. When a new implementation is desired (e.g., changing from a jammer to a bit error rate tester) instructions from a new bit file can be loaded.

It may be that a network diagnostic function is part of a “port personality” represented in a bit file. For example, a port personality can include a network diagnostic function, a speed (e.g., 1.065, 2.5, or 10.3125 Gigabits per second), and a protocol (e.g., Fiber Channel, Gigabit Ethernet, Infiniband, etc). Thus, a programmable logic module can process computer-executable or computer-interpretable instructions to cause a programmable logic module and a corresponding test port or test ports to interoperate to implement a port personality in accordance with the processed computer-executable or computer-interpretable instructions. For example, a programmable logic module can process instructions from a bit file to cause the programmable logic module and corresponding test ports to interoperate to implement a Fibre Channel jammer at 2.125 Gb/s. Accordingly, the personality of the corresponding test ports can include implementation of a Me particular network diagnostic function.

In some embodiments, a number of network diagnostic modules are included in a common chassis computer system. Thus, chassis computer systems with increased numbers of flexibly configurable test ports can be utilized to test a network. A common chassis computer system can include a mass storage interface for transferring network diagnostic data to and/or from a mass storage device, a trigger port for detecting the occurrence of events, an interconnect port for connecting to other chasses, and a remote access port for receiving commands from remote computer systems. Connected chasses can exchange control signals over links between corresponding interconnect ports. Accordingly, network diagnostic modules at a number of different chasses can be controlled from any of the other chasses. Connecting a number of chasses together can further increase the number test ports utilized to test a network.

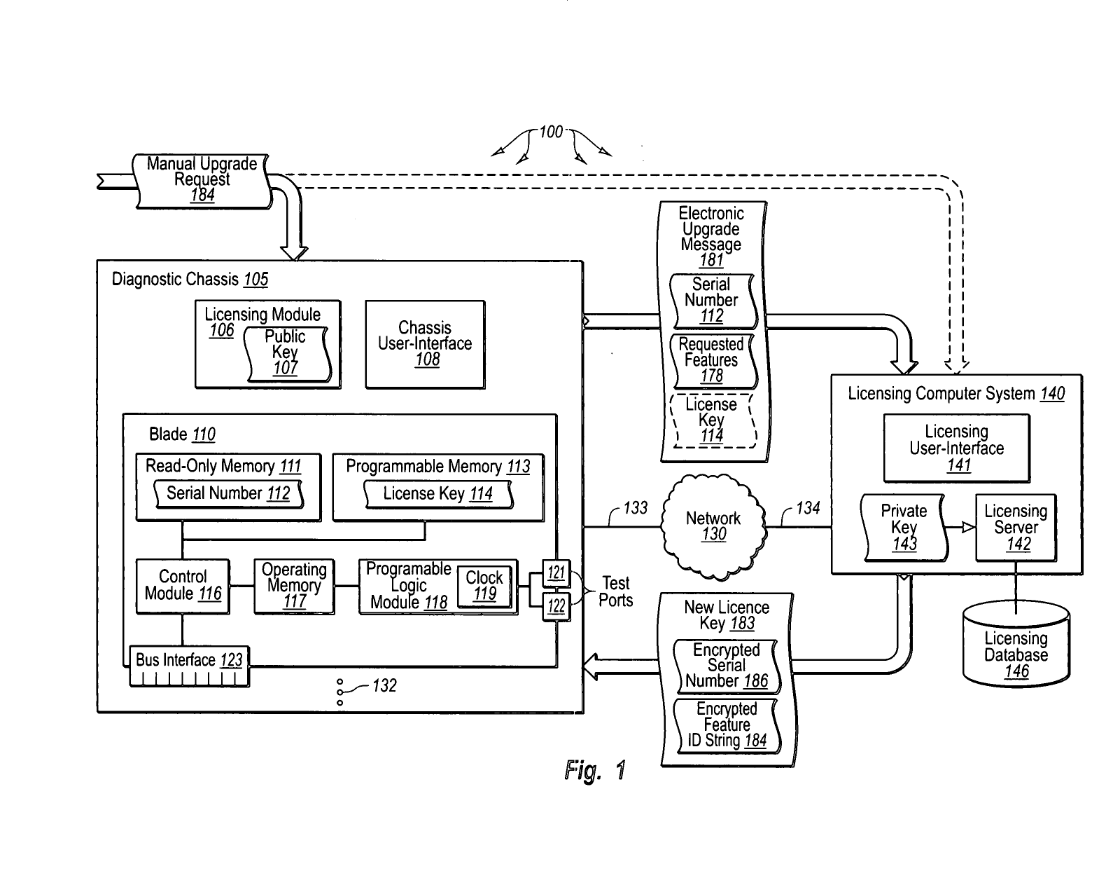

FIG. 1 illustrates an example of network architecture 100 and associated modules and data structures for remotely licensing configurable network diagnostic modules in accordance with the principles of the present invention. FIG. 1 depicts diagnostic chassis 105, which may be a chassis computer system. Diagnostic chassis 105 includes licensing module 106, chassis user-interface 108, and blade 110 that can interact to implement the principles of the present invention. Diagnostic chassis 105 is expressly depicted as including one blade (blade 110). However, vertical ellipsis 132 represents that diagnostic chassis 105 can include one or more additional blades. Each blade can include one or more programmable logic modules (similar to programmable logic module 118) that are currently interoperating with one or more test ports to implement network diagnostic functions. For example, programmable logic module 118 can be interoperating with test ports 121 and 122 to implement an SONET network analyzer.

Blade 110 includes read-only memory 111 that stores serial number 112. Read-only memory 111 can be any type of nonvolatile memory, such as, for example, a ROM chip, that retains its contents even when power is removed from blade 1110. Serial number 112 can be a prerecorded value identifying blade 110 that is stored in read-only memory 111 during the manufacturing of blade 110. Blade 110 further includes programmable memory 113 that stores license key 114. Programmable memory 113 can be a type of memory, such as, for example, an EEPROM chip or flash memory chip, that is programmable yet retains its contents even when power is removed from blade 110. Licensing key 114 can include licensing data (e.g., a feature ID string) that indicates the licensed features (e.g., speeds, protocols, and network diagnostic functions) of blade 110.

Licensing module 106 can include appropriate instructions for erasing the contents of programmable memory 113 (e.g., causing programmable memory 113 to be exposed to an electrical charge) and for programming new contents into programmable memory 113. Licensing module 106 can be configured to read and retrieve serial numbers and license keys, program license keys into programmable memory (e.g., EEPROMs), and decrypt license keys to reveal serial numbers and licensed feature sets. Decryption can include utilizing public key 107 to decrypt license keys that were encrypted using a private key corresponding to public key 107. Public key 107 can be embedded in computer-executable or computer-interpretable instructions of licensing module 106 such that it is obscured from users of diagnostic chassis 105.

Chassis user-Interface 108 (e.g., a Web-based interface) can be configured to present serial numbers, license keys, and licensed feature sets at an output device (e.g., a computer monitor). For example, chassis user-interface 108 can display blade feature sets including speeds, protocols, and network diagnostic functionality. Chassis user-interface 108 can also be configured to receive license keys entered at an input device (e.g., a keyboard and/or mouse). Licensing module 106 and chassis user-interface 108 can interoperate to allow a user of diagnostic chassis 105 to view and update license keys for blade 110 (or other blades included in diagnostic chassis 105).

Network architecture 100 also depicts licensing computer system 140. Licensing computer system 140 includes licensing user-interface 141, licensing server 142, and private key 143 that can interact to implement the principles of the present invention. Licensing server 142 can generate licensing keys based on serial numbers and features sets, maintain a central database of license keys (e.g., licensing database 146), and maintain a list of users who are authorized to access licensing server 142. Licensing server 142 can encrypt a serial number along with licensing data (e.g., a feature ID string) to generate a license key. Encryption can include utilizing private key 143 to encrypt license keys that can then be decrypted with a public key corresponding to private key 143. Licensing user-interface 141 (e.g., a Web-based interface) provides an interface for logging into licensing server 142, displaying blade license numbers and feature sets, licensing new features (e.g., speed, protocol, and network diagnostic function), and sending blade serial numbers and feature sets to the licensing server 142.

Public key 107 and private key 143 can be a corresponding public/private key pair.

Network 130 can be a Local Area Network (“LAN”), Wide Area Network (“WAN”) or even the Internet. Diagnostic chassis 105 and licensing computer system 140 are connected to network 130 by corresponding links 133 and 134. Diagnostic chassis 105 and licensing computer system 140 can utilize network 130 to send and/or receive electronic messages. Diagnostic chassis 105 and licensing computer system 140 can compatibility transfer electronic messages in accordance with any number of different protocols, such as, for example, Internet Protocol (“IP”) and other protocols (e.g., Transmission Control Protocol (“TCP”), Simple Mail Transfer Protocol (“SMTP”), and HyperText Transfer Protocol (“HTTP”)) that utilize IP.

In some embodiments, a user of diagnostic chassis 105 contacts a licensing representative, for example, by telephone, to request a license for new features to be implemented at blade 110 (or other blade included in diagnostic chassis 105). The user provides the serial number, requested new features, and possibly also the current license key to the licensing representative. The licensing representative enters the provided information at licensing user-interface 141, which transfers the provided information on to licensing server 142. Licensing server 142 can decrypt a provided license key (licensing server 142 may have access to public key 107) to reveal existing licensing data (e.g., a feature ID string) representing the features currently licensed for blade 110. Alternately, licensing server 142 can retrieve licensing data for blade 110 from licensing database 146 based on the provided serial number. Existing licensing data can be presented to the licensing representative at licensing user-interface 141.

The licensing representative can retrieve and/or enter new licensing data (e.g., a new feature ID string) that collectively represents both the currently licensed features of blade 110 and the requested new features. It may be that new licensing data is retrieved from licensing database 146. Alternately, licensing computer system 140 automatically formulates new licensing data (e.g., a new feature ID string) based on the serial number, requested new features, and/or current license key entered by the licensing representative. The serial number and new licensing data are transferred to licensing server 142. Licensing server 142 utilizes private key 143 to encrypt the serial number and new licensing data into a new license key.

In other embodiments, diagnostic chassis 105 is configured to electronically request a license for new features to be implemented at blade 110 (or other blade included in diagnostic chassis 105). Diagnostic chassis 105 can issue an electronic upgrade message in response to user input received at chassis user-interface 108. In response to user input, licensing module 106 can retrieve serial number 112 and can include serial number 112 along with requested features in an electronic upgrade message that is sent to licensing computer system 140. Optionally, licensing module 106 can also retrieve and include license key 114 in the electronic upgrade message.

Licensing server 142 can receive an electronic upgrade message and formulate a new license key for blade 110. Licensing server 142 can decrypt a received licensing key (licensing server 142 may have access to public key 107) to reveal existing licensing data (e.g., a feature ID string) representing the features currently licensed for blade 110. Alternately, licensing server 142 can retrieve existing licensing data for blade 110 from licensing database 146 based on serial number 112. Licensing server 146 can formulate new licensing data (e.g., a new feature ID string) that collectively represents both the currently licensed features of blade 110 and the requested new features. Licensing server 142 utilizes private key 143 to encrypt the serial number and new licensing data into a new license key.

Accordingly, in response to either a user request or an electronic request, and when appropriate (e.g., when a method of payment has been verified), licensing computer system 140 returns a new license key to diagnostic chassis 105. Diagnostic chassis 105 receives a new license key from licensing computer system 140. The new license key includes licensing data (e.g., a new feature ID string) collectively representing both the currently licensed features of blade 110 and the requested new features. Licensing module 106 can load the new license key into programmable memory 113, potentially overwriting license key 114.

Since the new license key is programmed into the hardware of blade 110 (specifically into programmable memory 113), blade 110 remains licensed for the requested new features even when blade 110 is included in a new diagnostic chassis (other than diagnostic chassis 105). When included in a new diagnostic chassis, a new licensing module at the new diagnostic chassis can retrieve and decrypt the new license key to reveal the licensed features of blade 110. Thus, the new licensing module can permit blade 110 to load bit files corresponding to any of the licensed features. Maintaining license keys in blade hardware allows blades to be easily moved between diagnostic chassis to meet the testing needs of different network testing environments.

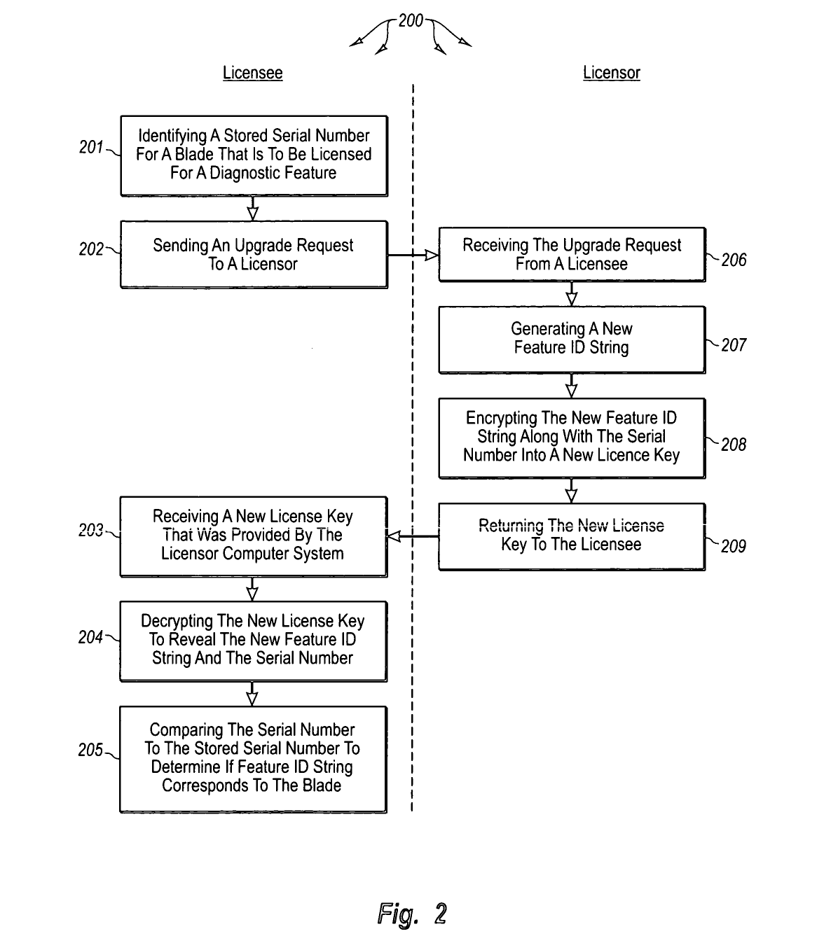

FIG. 2 illustrates a flowchart of a method 200 for remotely licensing a network diagnostic module in accordance with the principles of the present invention. The method 200 will be discussed with respect to the modules and data structures depicted in network architecture 100. The method 200 includes an act of identifying a stored serial number for a blade that is to be licensed for a new diagnostic feature (act 201). Act 201 can include a licensee entity, such as, for example, diagnostic chassis 105 or a user of diagnostic chassis 105, identifying a stored serial number for a blade that is to be licensed for a new diagnostic feature. For example, when blade 110 is to be licensed for a new diagnostic feature, a user of diagnostic chassis 105 can issue manual upgrade request 184 that causes user-interface 108 to present serial number 112 (retrieved by licensing module 106) to a user. Alternatley, when blade 110 is to be licensed for a new diagnostic feature, manual upgrade request 184 can cause licensing module 106 to retrieve serial number 112 for inclusion in an electronic upgrade message.

The method 200 includes an act of sending an upgrade request to a licensor (act 202). Act 202 can include a licensee entity, such as, for example, diagnostic chassis 105 or a user of diagnostic chassis 105, sending an upgrade request to a licensor entity, such as, for example, a licensing representative or licensing computer system 140. For example as indicated by the dashed line, a user of diagnostic chassis 105 can provide manual upgrade request 184 (e.g., via telephonic communication) to a licensing representative that is authorized to use licensing server 142. Manual upgrade request can include serial number 112, requested features, and potentially license key 114. Alternatley, diagnostic chassis 105 can send electronic upgrade message 181 to licensing computer system 140. As depicted, electronic upgrade message 181 includes serial number 112, requested features 178, and, as indicated by the dashed line, optionally includes license key 114.

The method 200 includes an act of receiving the upgrade request from the licensee (act 206). Act 206 can include a licensor entity, such as, for example, a licensing representative or licensing computer system 140, receiving an upgrade request from a licensee entity, such as, for example, diagnostic chassis 105 or a user of diagnostic chassis 105. For example, manual upgrade request 184 can be received by a licensing representative that subsequently enters serial number 112, requested features, and optionally license key 114 at licensing user-interface 141. Alternatley, licensing computer system 140 can receive electronic upgrade message 181.

The method 200 includes an act of generating a new feature ID string (act 207). Act 207 can include a licensor entity, such as, for example, a licensing representative or licensing computer system 140, generating a new feature ID that collectively represents the currently licensed features of blade 110 and the requested new features. Licensing server 142 can refer to licensing database 146 to retrieve currently licensed features of blade 110 based on serial number 112. Alternatley, licensing server 142 can decrypt license key 114 (licensing server 142 may have access to public key 107) to reveal the currently licensed features of blade 110.

The method 200 includes an act of encrypting the new feature ID string along with the serial number into a new license key (act 208). Act 208 can include a licensing server encrypting the new feature ID string along with the serial number into a new license key. For example, licensing server 142 can encrypt a new feature ID string 184 and serial number 112 into new license key 183. Licensing server 142 can utilize private key 143 to encrypt new feature ID string 184 and serial number 186 into new license key 183. Since the new feature ID string 184 is encrypted it has a reduced chance of providing a malicious user with any information on how licensing strings are formulated. Serial number 186 corresponds to the serial number of the blade that is to be licensed for the new features.

The method 200 includes an act of returning the new license key to the licensee (act 209). Act 209 can include the licensing computer system returning the new license key to the licensee. For example, licensing computer system 140 can send an electronic mail message including the new license key to a user of diagnostic chassis 105. The user can subsequently enter the new license key at chassis user-interface 108. Alternatley, licensing computer system 140 can send an electronic message including license key 183 directly to diagnostic chassis 105. As depicted in network architecture 100, new license key 183 includes encrypted serial number 186 and encrypted feature ID string 184.

The method 200 includes an act of receiving the new license key provided by the licensor computer system (act 203). Act 203 can include a diagnostic chassis receiving the new license key provided by the licensor computer system. For example, a user of diagnostic chassis 105 can enter a new license key that was received in an electronic mail message received from licensing computer system 140. Alternatley, diagnostic chassis 105 can receive an electronic message including new license key 183 directly from licensing computer system 140.

Upon receiving new license key 183, licensing module 106 can store new license key 183 in programmable memory 113. New licensing key 183 may overwrite existing license key 114.

The method 200 includes an act of decrypting the new licensing key to reveal the new feature ID string and the serial number (act 204). Act 204 can include a licensing module decrypting the new licensing key to reveal the new feature ID string and the serial number. For example, licensing module 106 can decrypt new license key 183 to reveal an unencrypted serial number 186 and an unencrypted feature ID string 184. Licensing module 106 can utilize public key 107 to decrypt new license key 183.

The method 200 includes an act of comparing the serial number to the stored serial number to determine if the feature ID string corresponds to the blade (act 205). Act 205 can include a licensing module comparing the serial number to the stored serial number to determine if the feature ID string corresponds to the blade. For example, licensing module 106 can compare serial number 186 to serial 112 to determine if feature string ID 184 corresponds to blade 110.

When a stored serial number (e.g., serial number 112) matches a serial number (e.g., serial number 186) in a new license key (e.g., new license key 183), this can indicate that the blade storing the new license key (e.g., blade 110) is licensed to implement the features represented in the feature ID string (e.g., feature ID string 184) of the new license key. Accordingly, a licensing module can allow the blade to load bit files that implement the represented features. On the other hand, when a stored serial number does not match a serial number in a new license key, this can indicate that the features represented in the feature ID string do not correspond to the blade storing the new license key. Thus, the blade may not be licensed to implement the features represented in the feature ID string (e.g., feature ID string 184 of the new license key. Accordingly, a licensing module can prevent the blade from loading bit files that implement the represented features.

It may be that licensing modules similar to licensing module 106 are included in a plurality of different diagnostics chasses. For example, these similar licensing modules may be part of installation software that is provided when a diagnostic chassis is received. During execution of the installation software these similar licensing modules can be loaded onto the diagnostic chasses. Thus, it may be that public key 107 is embedded in a licensing module at each diagnostic chassis in the plurality of different diagnostic chasses. Accordingly, if blade 110 is removed from diagnostic chassis 105 and included in a new diagnostic chassis, the new diagnostic chassis can decrypt new license key 183 and perform a comparison similar to that of act 205. Thus, licensed features of blade 110 are easily identifiable at a new diagnostic chassis even though the licensed features were upgraded when blade 110 was included in diagnostic chassis 105.

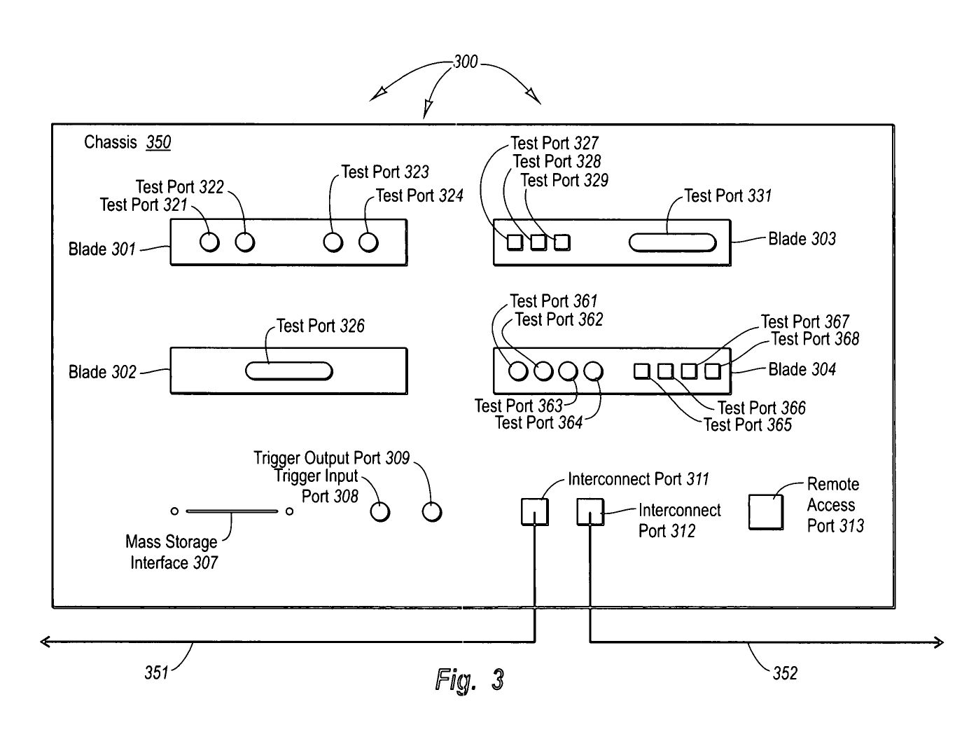

FIG. 3 illustrates an example computer system architecture 300 including a plurality of network diagnostic modules in accordance with the principles of the present invention. Depicted in computer system architecture 300 is chassis 350, which includes blades 301, 302, 303, and 304. Although not expressly depicted, each of blades 301, 302, 303, and 304 are coupled, through an appropriate bus interface, to a computer system bus of chassis 350. For example, each of blades 301, 302, 303, and 304 can include PCI bus interfaces that are inserted into PCI receptacles at chassis 350. Accordingly, computer-executable or computer-interpretable instructions can be transferred over the computer system bus to blades 301, 302, 303, and 304 to configure and re-configure corresponding test ports.

Blades coupled to a chassis can have different numbers and configurations of test ports. For example, depicted at blade 301 test ports 321, 322, 323 and 324 can each be SFP ports. Depicted at blade 303 test ports 327, 328 and 329 can be RJ-45 ports and test port 331 can be a 300-pin MSA port. Depicted at blade 302 test port 326 can be a 300-pin MSA port. Depicted at blade 304 test ports 361, 362, 363, and 364 can be SFP ports and test ports 365, 366, 367, and 368 can be RJ-45 ports. Accordingly, the test ports of chassis 350 can be simultaneously connected to the same or a variety of different networks, such as, for example, 10 Gigabit Ethernet, 100 Megabit Ethernet, Infiniband, and SONET networks, to implement the same or a variety of different network diagnostic functions (e.g., to implement specified port personalities).

Mass storage interface 307 can be an interface for coupling to mass storage devices. For example, mass storage interface 307 may be a Small Computer System Interface (“SCSI”) that is coupled to a SCSI hard drive. Accordingly, as network diagnostic data is collected at blades 301, 302, 303, and 304, the network diagnostic data can be transferred to the SCSI hard drive for storage.

Interconnect ports 311 and 312 (e.g., RJ-11 ports) can be utilized to connect chassis 350 to other chasses (not shown). Connections from chassis 350 to other chasses, for example, as illustrated by links 351 and 352, can be utilized to transfer control signals that coordinate the collection of network diagnostic data. For example, the collection of network diagnostic data for a network analyzer implemented in blade 304 can be coordinated with the collection of network diagnostic data for a bit error rate tester implemented at another chassis coupled to link 351. Accordingly, through the exchange of control signals, it may be that test ports at a plurality of different chasses are configured to implement network diagnostic functions in a coordinated manner.

Trigger input port 308 and trigger output port 309 (e.g., TTL ports) can be utilized to transfer trigger signals to and from chassis 350. Generally, trigger signals can indicate the occurrence of an event to a chassis. In response to the occurrence of an event, a chassis can activate or deactivate network diagnostic functionality. For example, it may be that a programmable logic module controlling test port 326 is implementing a bit error rate tester. However, it may be desirable to activate bit error rate testing of a network coupled to port 326 only when a particular computer system is transmitting data onto the network. An appropriate mechanism for detecting when the particular computer system is transmitting data can be utilized to generate a trigger signal.

When a trigger signal is received at trigger input port 308, bit error rate testing through port test 326 can be activated. When the trigger signal is not longer received at trigger input port 308, bit error rate testing through test port 326 can be deactivated. In some embodiments, for example, when a plurality of chasses are connected, trigger inputs and outputs of different chasses can be coupled together so that the chasses receive the same triggers. For example, trigger input port 308 can be coupled to a trigger output port of a chassis connected to link 351 and/or trigger output port 309 can be coupled to a trigger input port of a chassis connected to link 352. Accordingly, when test ports at a plurality of different chasses are configured to perform coordinated network diagnostic functions, the network diagnostic functions can be activated and deactivated in response to the same events.

Remote access port 313 (e.g., an RJ-45 port) can be utilized to remotely configure chassis 350. Through remote access port 313, chassis 350 can be coupled to a (“WAN”), along with one or more other computer systems. The other computer systems can utilize the network to access configuration information from chassis 350. The other computer systems can also initiate configuration requests to configure or re-configure ports included in chassis 350. Accordingly, an administrator or user at a remote computer system can configure the test ports of chassis 350 (as well as configuring test ports at other chasses connected to the network) to implement selected network diagnostic functions.

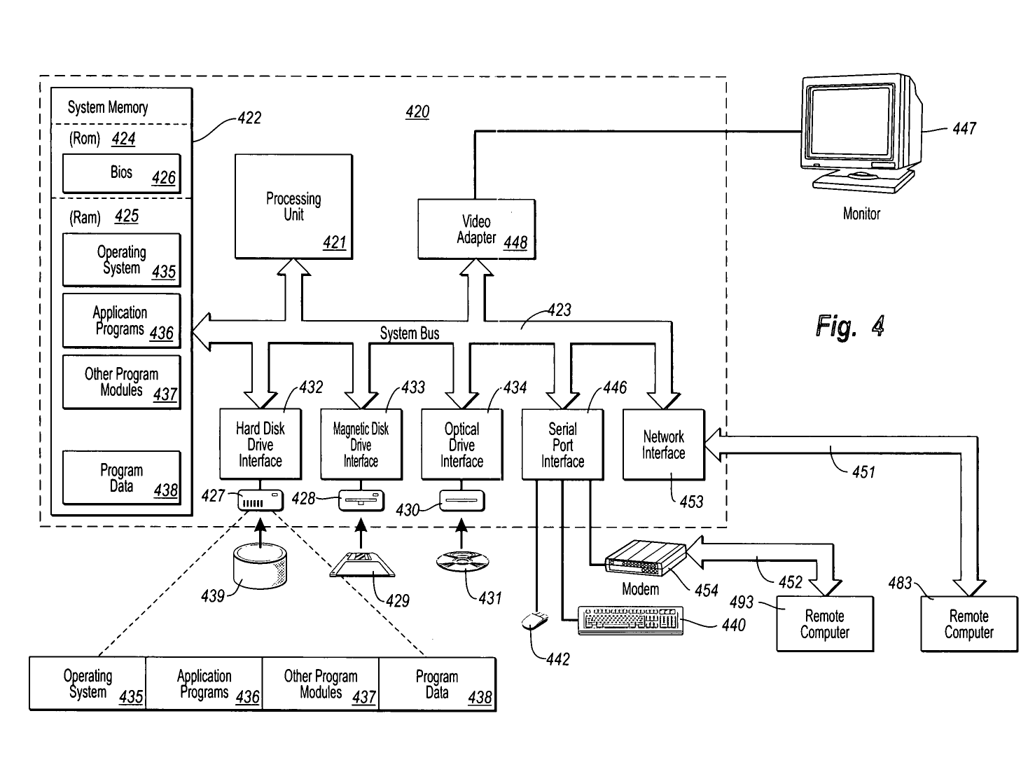

FIG. 4 illustrates a suitable operating environment for the principles of the present invention. FIG. 4 and the following discussion are intended to provide a brief, general description of a suitable computing environment in which the invention may be implemented. With reference to FIG. 4, an example system for implementing the invention includes a general-purpose computing device (e.g., a diagnostic chassis) in the form of computer system 420.

Computer system 420 includes a processing unit 421, a system memory 422, and a system bus 423 that couples various system components including the system memory 422 to the processing unit 421. Processing unit 421 can execute computer-executable instructions designed to implement features of computer system 420, including features of the present invention. The system bus 423 may be any of several types of bus structures including a memory bus or memory controller, a PCI bus, a peripheral bus, and a local bus using any of a variety of bus architectures. Computer system 420 can include one or more receptacles for receiving print circuit boards or “cards” that interface with system bus 423. Me System memory 422 includes read only memory (“ROM”) 424 and random access memory (“RAM”) 425. A basic input/output system (“BIOS”) 426, containing the basic routines that help transfer information between elements within the computer 420, such as during start-up, may be stored in ROM 424.

The computer system 420 may also include a magnetic hard disk drive 427 (e.g., a SCSI drive) for reading from and writing to a magnetic hard disk 439, a magnetic disk drive 428 for reading from or writing to a removable magnetic disk 429, and an optical disk drive 430 for reading from or writing to removable optical disk 431, such as, or example, a CD-ROM or other optical media. The magnetic hard disk drive 427, magnetic disk drive 428, and optical disk drive 430 are connected to the system bus 423 by hard disk drive interface 432, magnetic disk drive-interface 433, and optical drive interface 434, respectively. The drives and their associated computer-readable media provide nonvolatile storage of computer-executable instructions, data structures, program modules, and other data for computer system 420. Although the example environment described herein employs a magnetic hard disk 439, a removable magnetic disk 429 and a removable optical disk 431, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 439, magnetic disk 429, optical disk 431, ROM 424 or RAM 425, including an operating system 435, one or more application programs 436, other program modules 437 (e.g., bit files), and program data 438. A user may enter commands and information into the computer system 420 through keyboard 440, pointing device 442, or other input devices (not shown), such as, for example, a microphone, joy stick, game pad, scanner, or the like. These and other input devices can be connected to the processing unit 421 through serial port interface 446 coupled to system bus 423. Alternatively, input devices can be connected by other interfaces, such as, for example, a parallel port, a game port, a universal serial bus (“USB”) port, or a Fire Wire port. A monitor 447 or other display device is also connected to system bus 423 via video adapter 448. Computer system 420 can also be connected to other peripheral output devices (not shown), such as, for example, speakers and printers.

Computer system 420 is connectable to networks, such as, for example, an office-wide or enterprise-wide computer network, an intranet, and/or the Internet. Computer system 420 can exchange data with external sources, such as, for example, remote computer systems, computer system chasses containing network diagnostic modules, remote applications, and/or remote databases over such a network.

Computer system 420 includes network interface 453, through which computer system 420 receives data from external sources and/or transmits data to external sources. As depicted in FIG. 4, network interface 453 facilitates the exchange of data with remote computer system 483 via link 451. Link 451 represents a portion of a network, and remote computer system 483 represents a node of the network (e.g., a chassis computer system).

Likewise, computer system 420 includes serial port interface 446, through which computer system 420 receives data from external sources and/or transmits data to external sources. Serial port interface 446 is coupled to modem 454, through which computer system 420 receives data from and/or transmits data to external sources. Alternately, modem 454 can be a Data Over Cable Service Interface Specification (“DOCSIS”) modem or digital subscriber lines (“DSL”) modem that is connected to computer system 420 through an appropriate interface. However, as depicted in FIG. 4, serial port interface 446 and modem 454 facilitate the exchange of data with remote computer system 493 via link 452. Link 452 represents a portion of a network, and remote computer system 493 represents a node of the network (e.g., a chassis computer system).

While FIG. 4 represents a suitable operating environment for the present invention, the principles of the present invention may be employed in any system that is capable of, with suitable modification if necessary, implementing the principles of the present invention. The environment illustrated in FIG. 4 is illustrative only and by no means represents even a small portion of the wide variety of environments in which the principles of the present invention may be implemented.

Modules of the present invention, as well as associated data, can be stored and accessed from any of the computer-readable media associated with computer system 420. For example, portions of such modules and portions of associated program data may be included in operating system 435, application programs 436, program modules 437 and/or program data 438, for storage in system memory 422. When a mass storage device, such as, for example, magnetic hard disk 439, is coupled to computer system 420, such modules and associated program data may also be stored in the mass storage device. In a networked environment, program modules and associated data depicted relative to computer system 420, or portions thereof, can be stored in remote memory storage devices, such as, for example, system memory and/or mass storage devices associated with remote computer system 483 and/or remote computer system 493. Execution of such modules may be performed in a distributed manner.

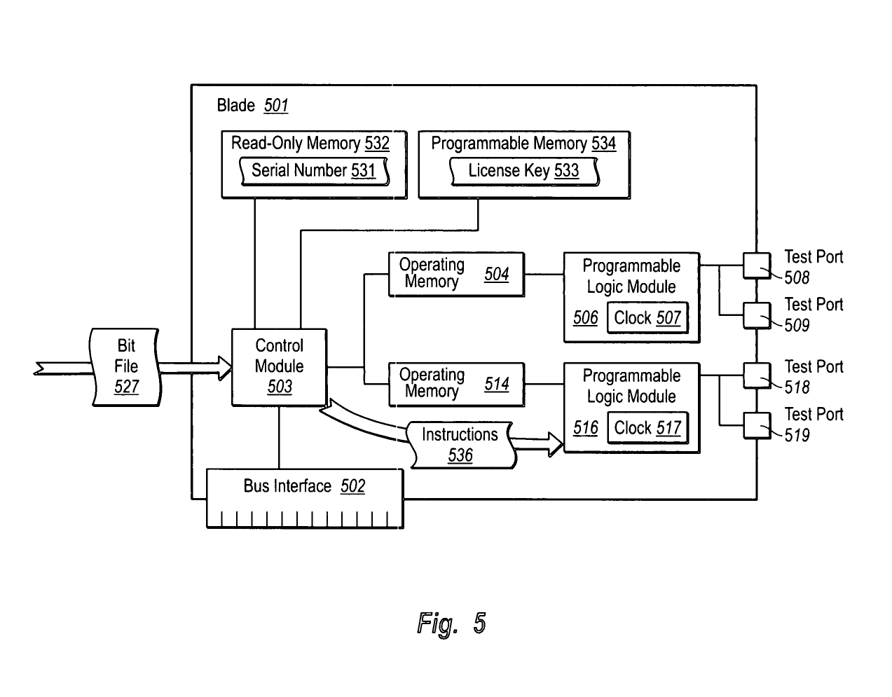

FIG. 5 illustrates an example of a network diagnostic module and test ports that can interoperate to implement a network diagnostic function. The network diagnostic module and test ports are implemented in blade 501, which can be a printed circuit board. Bus interface 502 can be inserted into an appropriate receptacle (e.g., a Peripheral Component Interconnect (“PCI”) interface) at a computer system (e.g., at a diagnostic chassis) to communicatively couple blade 501 to the computer system. Blade 501 can communicate (e.g., sending and receiving appropriate electrical signaling) with a corresponding computer system bus (e.g., a PCI bus) through bus interface 502.

Blade 501 includes operating memory 504 and programmable logic module 506 that control the functionality of test ports 508 and 509. Operating memory 504 can be any of a variety of different types of memory, such as, for example, Random Access Memory (“RAM”). Operating memory 504 can be used to store instructions for programmable logic module 506 and to buffer data that is transferred between programmable logic module 506 and control module 503. Programmable logic module 506 can be virtually any type of programmable circuit, such as, for example, a Field-Programmable Gate Array (“FPGA”), Programmable Logic Array (“PLA”), or other type programmable logic device. Programmable logic module 506 can include circuitry for implementing any of a plurality of network diagnostic functions (e.g., network analyzer, jammer, generator, bit error rate tester, etc).

Accordingly, programmable logic module 506 can process computer-executable or computer-interpretable instructions to cause programmable logic module 506 and test port 508 and/or test port 509 to interoperate to implement a port personality in accordance with the processed computer-executable or computer-interpretable instructions. For example, programmable logic module 506 can process instructions from a bit file to cause programmable logic module 506 and test ports 508 and test port 509 to interoperate to implement a Fiber Channel jammer at 2.125 Gb/s. Accordingly, the personality of test port 508 and the personality of test port 509 can include implementation of a particular network diagnostic function.

It may that a plurality of test ports are utilized together to implement a particular network diagnostic function. For example, test ports 508 and 509 can be utilized together to implement a network analyzer. On the other hand, it may be a first test port is utilized to implement a first network diagnostic function, while a second different test port is simultaneously utilized to implement a second different network diagnostic function. For example, test port 508 can be utilized to implement a generator, while test port 509 is simultaneously utilized to implement a bit error rate tester. Instructions from an appropriate bit file can be loaded (e.g., after an appropriate licensing check at a diagnostic chassis containing blade 501) at programmable logic module 506 to cause test port 508 and test port 509 to simultaneously implement different network diagnostic functions. Clock 507 can coordinate the appropriate timing of data transferred to and from test port 508 and test port 509

Blade 501 also includes operating memory 514 and programmable logic module 516 that control the functionality of test ports 518 and 519. Similar to operating memory 504, operating memory 514 can be any of a variety of different types of memory, such as, for example, Random Access Memory (“RAM”). Operating memory 514 can be used to store instructions for programmable logic module 516 and to buffer data that is transferred between programmable logic module 516 and control module 503. Similar to programmable logic module 506, programmable logic module 516 can be virtually any type of programmable circuit, such as, for example, a Field-Programmable Gate Array (“FPGA”), Programmable Logic Array (“PLA”), or other type programmable logic device. Similar to programmable logic module 506, programmable logic module 516 can include circuitry form implementing any of a plurality of network diagnostic functions (e.g., network analyzer, jammer, generator, or bit error rate tester, etc). Although not required, it may be that programmable module 506 and programmable logic module 516 are the same type of programmable logic module.

Similar to programmable logic module 506, programmable logic module 516 can process computer-executable or computer-interpretable instructions (e.g., instructions 536) to cause programmable logic module 516 and test port 518 and/or test port 519 to interoperate to implement a port personality (including network diagnostic function, speed, and protocol) in accordance with the processed computer-executable or computer-interpretable instructions. Test ports 518 and 519 can be utilized together to implement a particular network diagnostic function. On the other hand, test port 518 may be utilized to implement a first network diagnostic function, while test port 519 is utilize to implement a second different network diagnostic function.

For example, programmable logic module 516 can process instructions 536 from bit file 527 (e.g., after an appropriate licensing check at a diagnostic chassis containing blade 501) to cause programmable logic module 516 and test port 518 to interoperate to implement a Fiber Channel bit error rate test at 10.51875 Gb/s and to cause programmable logic module 516 and test port 519 to interoperate to implement a Inifiband generator at 1.065 Gb/s. A bit file having appropriate instructions can be loaded (e.g., after an appropriate licensing check at a diagnostic chassis containing blade 501) at programmable logic module 516 to cause test port 518 and test port 519 to simultaneously implement different network diagnostic functions. Clock 517 can coordinate the appropriate timing of data transferred to and from test port 518 and test port 519.

Test ports of different programmable logic modules can be configured to implement the same personalities. For example, programmable logic module 506 may process instructions that that cause test ports 508 and 509 to implement a Gigabit Ethernet analyzer at 1.065 GB/s, while programmable logic module 516 also processes instructions that cause test ports 518 and 519 to implement a Gigabit Ethernet analyzer at 1.065 GB/s. On the hand, test ports of different programmable logic modules can be configured to implement different personalities. For example, programmable logic module 506 may process instructions that that cause test ports 508 and 509 to implement a Fiber Channel analyzer at 2.125 GB/s, while programmable logic module 516 processes instructions that cause test ports 518 and 519 to implement an Infiniband analyzer at 10.51875 GB/s.

Test ports 508, 509, 518 and 519 can be of virtually any physical configuration, such as, for example, RJ-11, RJ-45, small form-factor pluggable (“SFP”), Universal Serial Bus (“USB”), IEEE 1394 (Firewire), 300-pin MSA, etc. Test ports 508, 509, 518 and 519 can also be physically configured to receive virtually any type of cabling, such as, for example, cabling that carries electrical signals or carries optical signals. Although not required, it may be that ports controlled by the same programmable logic module are configured as the same type of port. For example, test ports 508 and 509 (both controlled by programmable logic module 506) may both be SFP ports configured to receive optical cable.

Control module 503 coordinates the transfer of data between bus interface 502 and memories 504 and 514. Control module 503 can translate data received from bus interface 502 (e.g., a PCI interface) into a format that can be processed by programmable logic modules included in blade 501. Likewise, control module 503 can translate data received from a programmable logic module into a format that can be compatibly transferred over a computer system bus (e.g., a PCI bus) that is communicatively coupled to bus interface 502. Based on received data (e.g., appropriate addressing information), control module 503 can also identify the programmable logic module that is associated with the received data. Accordingly, control module 503 can transfer at least a portion of the received data (e.g., computer-executable or computer-interpretable instructions) to the associated programmable logic module.

Before bit file 527 is permitted to be received at control module 503, a licensing module in a corresponding diagnostic chassis can determine if blade 501 is licensed to implement the functionality represented in bit file 527. The corresponding diagnostic chassis can retrieve and decrypt license key 533 (e.g., using an appropriate public key) and compare a serial number included in license key 533 to serial number 531. If the serial numbers match and licensing data (e.g., a feature ID string) of license key 533 indicates that blade 501 is licensed to implement the functionality represented in bit file 527, the corresponding diagnostic chassis can permit bit file 527 to load. On the other hand, if a serial number in license key 533 and serial number 531 do not match, the corresponding diagnostic chassis does not permit bit file 527 to load. Similarly, if licensing data (e.g., a feature ID string) of license key 533 indicates that blade 501 is not licensed to implement the functionality represented in bit file 527, the corresponding diagnostic chassis does not permit bit file 527 to load. Storing serial number 531 in read-only memory (e.g., a ROM chip) increases the difficulty of altering serial number 531 to obtain unlicensed features.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. At a diagnostic chassis that includes one or more blades and is network connectable to a licensing computer system, a method for licensing a blade to implement a new diagnostic feature, the method comprising the acts of:
identifying a stored serial number for a blade that is to be licensed to implement a new diagnostic feature;
sending an upgrade request to a licensor entity;
receiving a new license key provided by the licensing computer system;
decrypting the new license key to reveal a new feature ID string and a serial number; and
comparing the serial number to the stored serial number to determine if the feature ID string corresponds to the blade.

2. The method as recited in claim 1, wherein the act of identifying a stored serial number for a blade that is to be licensed to implement a new diagnostic feature comprises an act of presenting the stored serial number at a user-interface.

3. The method as recited in claim 1, wherein the act of identifying a stored serial number for a blade that is to be licensed to implement a new diagnostic feature comprises an act of identify a stored serial number stored in read-only memory.

4. The method as recited in claim 1, wherein the act of sending an upgrade request to a licensor entity comprises an act of sending an electronic mail message including at least the stored serial number and an indication of the new diagnostic feature.

5. The method as recited in claim 4, wherein the electronic mail message further includes a current license key for the blade.

6. The method as recited in claim 1, wherein the act of sending an upgrade request to a licensor entity comprises an act of the diagnostic chassis sending an electronic upgrade message to the licensing computer system in response to user input.

7. The method as recited in claim 6, wherein the act of sending an electronic upgrade message to the licensing computer system comprises an act of sending an electronic upgrade message that includes at least the stored serial number and an indication of the new diagnostic feature.

8. The method as recited in claim 7, wherein the electronic upgrade message further includes a current license key for the blade.

9. The method as recited in claim 1, wherein the act of receiving a new license key provided by the licensing computer system comprises an act of receiving an electronic message that contains an encrypted serial number and an encrypted feature ID string.

10. The method as recited in claim 1, wherein the act of decrypting the new license key to reveal a new feature ID string and a serial number comprises an act of decrypting the new license key using a public key, the public key corresponding to a private key used to encrypt the license key.

11. The method as recited in claim 1, wherein the act of comparing the serial number to the stored serial number to determine if the feature ID string corresponds to the blade comprises an act of comparing the serial number to the stored serial number, the stored serial number being stored in read only memory of the blade.

12. The method as recited in claim 1, further comprising:
an act of storing the new license key in programmable memory at the blade such that if the blade is moved to a new diagnostic chassis the new license key is retained in the blade.

13. At a licensing computer system that is network connectable to a diagnostic chassis including one or more blades, a method for licensing a blade to implement a new diagnostic feature, the method comprising the acts of:
receiving an upgrade request from a licensee entity associated with the diagnostic chassis, the upgrade request including a blade serial number and requesting that a blade corresponding to the blade serial number be licensed to implement a new diagnostic feature;
generating a new feature ID string that collectively represents the current diagnostic functionality of the blade along with the new diagnostic feature;
encrypting the new feature string along with the serial number into a new license key; and
returning the new licensing key to the licensee entity.

14. The method as recited in claim 13, wherein the act of receiving an upgrade request from a licensee entity associated with the diagnostic chassis comprises an act of receiving an electronic mail message that includes at least the blade serial number and an indication of the new diagnostic feature.

15. The method as recited in claim 14, wherein the electronic mail message further includes a current license key for the blade.

16. The method as recited in claim 13, wherein the act of receiving an upgrade request message from a licensee entity associated with the diagnostic chassis comprises an act of the licensing computer system receiving an electronic upgrade message from the diagnostic chassis.

17. The method as recited in claim 16, wherein the act of licensing computer system receiving an electronic upgrade message from the diagnostic chassis comprises an act of receiving an electronic upgrade message that includes at least the blade serial number and an indication of the new diagnostic feature.

18. The method as recited in claim 17, wherein the electronic upgrade message further includes a current license key for the blade.

19. The method as recited in claim 13, wherein the act of encrypting the new feature ID string along with the serial number into a new license key comprises an act of utilizing a private key to encrypt the new feature ID string along with the serial number into a new license key, the private key having a corresponding public key that can be utilized to decrypt the new license key.

20. The method as recited in claim 13, wherein the act of returning the new licensing key to the licensee entity comprises an act of sending an electronic message to the diagnostic chassis.

21. The method as recited in claim 20, wherein the act of returning the new licensing key to the licensee entity comprises an act of sending an electronic message that includes the encrypted feature string and encrypted serial number.

22. A computer program product for sue at a diagnostic chassis that includes one or more blades and is network connectable to a licensing computer system, the computer program product for implementing a method for licensing a blade to implement a new diagnostic feature, the computer program product comprising one or more computer-readable media having stored thereon computer executable instructions that, when executed by a processor, cause the diagnostic chassis to perform the following:
identify a stored serial number for a blade that is to be licensed to implement a new diagnostic feature;
send an upgrade request to a licensor entity;
receive a new license key provided by the licensing computer system;
decrypt the new license key to reveal a new feature ID string and a serial number; and
compare the serial number to the stored serial number to determine if the feature ID string corresponds to the blade.

23. A computer program product for use at a licensing computer system that is network connectable to a diagnostic chassis including one or more blades, the computer program product for implementing a method for licensing a blade to implement a new diagnostic feature, the computer program product comprising one or more computer-readable media having stored thereon computer executable instructions that, when executed by a processor, cause the licensing computer system to perform the following:
receive an upgrade request from a licensee entity associated with the diagnostic chassis, the upgrade request including a blade serial number and requesting that a blade corresponding to the blade serial number be licensed to implement a new diagnostic feature;
generate a new feature ID string that collectively represents the current diagnostic functionality of the blade along with the new diagnostic feature;
encrypt the new feature string along with the serial number into a new license key; and
return the new licensing key to the licensee entity.
